(19) United States
(12) Patent Application Publication
(10) Pub. No.: US 2025/0021425 A1
(43) Pub. Date: Jan. 16, 2025

(54) MAINTAINING BACKUP SERVER HEALTH AND RESILIENCY USING ARTIFICIAL INTELLIGENCE

(71) Applicant: Dell Products L.P., Round Rock, TX (US)

(72) Inventors: Avinash Kumar, Patna (IN); Mahesh Reddy Av, Bangalore (IN); Terry O'Callaghan, Hopkinton, MA (US)

(21) Appl. No.: 18/352,251

(22) Filed: Jul. 14, 2023

(51) Int. Cl. G06F 11/07; G06F 11/14; G06N 5/022

(52) U.S. Cl. CPC G06F 11/0793; G06F 11/0709; G06F 11/079; G06F 11/1453; G06N 5/022; G06F 2201/805

(57) ABSTRACT

A data protection system implements a Naïve Bayes classifier-based server health resiliency process that greatly helps the amount of time needed to resolve any health-based issue in the server. The Naive Bayes is an example of a simple classifier that classifies based on probabilities of problematic or potential failure causing events. This helps empower vendor applications to intelligently identify automatically resolve these flaws without the need for vendor personnel on the customer environment. Such a process uses historical cases and trains machine learning models in such a way that troubleshooting, log analysis and recommendations will be done proactively to identify root causes of issue and identify and apply available and appropriate fixes and workarounds.

### TECHNICAL FIELD

Embodiments are generally directed to data protection systems, and more specifically to maintaining backup server health and resiliency using artificial intelligence.

### BACKGROUND

Data protection systems back up data from backup clients to storage media through a backup server executing data backup programs. Such data can then be restored to the original data sources after any system or data problem is resolved. In large-scale networks, backup servers, programs, and infrastructure are typically provided by a vendor for a user (customer) who purchases or subscribes to a data protection regime using the vendor platform. In general, users do not expect backup/restore operations to be impacted by internal backup server or backup network issues. Accordingly, when an internal backup server issue occurs, users must contact the vendor, who then troubleshoots the issue and provides a hardware or software fix or alternate platforms to continue the data protection processes. In this case, the user needs to wait until the issue is resolved through the vendor's customer service (e.g., service request, escalation, development) channels. This cycle of events can be very frustrating and time consuming and directly impact the user's satisfaction with respect to the data protection platform.

Present data protection systems thus require investing time and resources to fix an issue even if the issue is internal to the product or vendor. Such issues can cause significant delays in scheduled backup and restore operations. Present systems also require that any design related issues be addressed manually following the support services channels to keep the product up and running.

What is needed, therefore, is a system that provides some platform intelligence to facilitate self-healing of internal backup server issues.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions. Data Domain, Data Domain Restorer, and PowerProtect are trademarks of DellEMC Inc.

### BRIEF SUMMARY OF EMBODIMENTS

Embodiments include a data protection system that implements a Naïve Bayes classifier-based server health resiliency process that greatly helps the amount of time needed to resolve any health-based issue in the server. The Naive Bayes is an example of a simple classifier that classifies based on probabilities of problematic or potential failure causing events. This helps empower vendor applications to intelligently identify automatically resolve these flaws without the need for vendor personnel on the customer environment. Such a process uses historical cases and trains machine learning models in such a way that troubleshooting, log analysis and recommendations will be done proactively to identify root causes of issue and identify and apply available and appropriate fixes and workarounds. Other possible AI based classifiers include KNN, RNN, and SVM classification methods.

### BRIEF DESCRIPTION OF THE DRAWINGS

In the following drawings like reference numerals designate like structural elements. Although the figures depict various examples, the one or more embodiments and implementations described herein are not limited to the examples depicted in the figures.

FIG. 1 illustrates a computer network system that implements one or more embodiments of a backup system implementing a backup server health and resiliency process.

FIG. 2 is a block diagram of a self-healing component for maintaining backup server health, under some embodiments.

FIG. 3 is a flowchart illustrating a method of performing AI-based server health and resiliency, under some embodiments.

FIG. 4 illustrates a simple example depiction of a KNN implementation that can be used for a server health and resiliency component, under some embodiments.

FIG. 5 illustrates a plot representation for the calculation of Euclidean distance for a KNN implementation, under some embodiments.

FIG. 6 illustrates a general AI/ML component used in a server health and resiliency component, under some embodiments.

FIG. 7 shows a system block diagram of a computer system used to execute one or more software components of the present system described herein.

### DETAILED DESCRIPTION

A detailed description of one or more embodiments is provided below along with accompanying figures that illustrate the principles of the described embodiments. While aspects of the invention are described in conjunction with such embodiment(s), it should be understood that it is not limited to any one embodiment. On the contrary, the scope is limited only by the claims and the invention encompasses numerous alternatives, modifications, and equivalents. For the purpose of example, numerous specific details are set forth in the following description in order to provide a thorough understanding of the described embodiments, which may be practiced according to the claims without some or all of these specific details. For the purpose of clarity, technical material that is known in the technical fields related to the embodiments has not been described in detail so that the described embodiments are not unnecessarily obscured.

It should be appreciated that the described embodiments can be implemented in numerous ways, including as a process, an apparatus, a system, a device, a method, or a computer-readable medium such as a computer-readable storage medium containing computer-readable instructions or computer program code, or as a computer program product, comprising a computer-usable medium having a computer-readable program code embodied therein. In the context of this disclosure, a computer-usable medium or computer-readable medium may be any physical medium that can contain or store the program for use by or in connection with the instruction execution system, apparatus or device. For example, the computer-readable storage medium or computer-usable medium may be, but is not limited to, a random access memory (RAM), read-only memory (ROM), or a persistent store, such as a mass storage device, hard drives, CDROM, DVDROM, tape, erasable programmable read-only memory (EPROM or flash memory), or any magnetic, electromagnetic, optical, or electrical means or system, apparatus or device for storing information. Alternatively or additionally, the computer-readable storage medium or computer-usable medium may be any combination of these devices or even paper or another suitable medium upon which the program code is printed, as the program code can be electronically captured, via, for instance, optical scanning of the paper or other medium, then compiled, interpreted, or otherwise processed in a suitable manner, if necessary, and then stored in a computer memory. Applications, software programs or computer-readable instructions may be referred to as components or modules. In this specification, implementations, or any other form that the invention may take, may be referred to as techniques. In general, the order of the steps of disclosed processes may be altered within the scope of the invention.

Some embodiments of the invention certain computer network techniques deployment in a distributed system, such as a very large-scale wide area network (WAN), metropolitan area network (MAN), or cloud based network system, however, those skilled in the art will appreciate that embodiments are not limited thereto, and may include smaller-scale networks, such as LANs (local area networks). Thus, aspects of the one or more embodiments described herein may be implemented on one or more computers executing software instructions, and the computers may be networked in a client-server arrangement or similar distributed computer network.

Data protection systems involve backing up data at regular intervals for restoration, replication, or data move operations based on user need and/or data corruption events. To reduce the sheer amount of data that is backed up and stored, such systems typically use some form of deduplication to eliminate redundant copies of data, such as might be present with data that is frequently backed up, but not as frequently changed in between each backup period.

The Data Domain File System (DDFS) is an example of one such deduplication file system. As the data is ingested, the filesystem anchors and segments the data. The filesystem keeps track of segments which are stored on the disk, and if the segments were to be seen again, the filesystem would just store the reference to the original data segment which was written to disk. Deduplication backups often involve periodic full backups of backup clients by the backup server followed by one or more incremental backups that backup only that data that has changed from a last full backup. Because of the sheer number of backup clients and the amount of data in a large scale data processing system, such backups can be very time and processor intensive.

In order to provide appropriate backup protection to users, data protection vendors often implement certain service level agreements (SLAs) and/or service level objectives (SLOs) to define and quantify certain minimum requirements with regard to backup performance. These parameters usually define characteristics such as maximum backup time per session, minimum data throughput rates, maximum data restore times, data storage terms, and so on. The vendor and/or user is allowed to define policies that control backup operations, such as backup schedules, identity and priority of backup clients and storage targets, backup data types, and so on, and such policies are usually written so that the SLA and SLO requirements are met. However, the dynamic and changing nature of different clients and data types in a backup dataset means that these policies must be similarly adaptable and dynamic to accommodate such changes.

Some embodiments involve software and systems deployed in a distributed system, such as a cloud based network system or very large-scale wide area network (WAN), metropolitan area network (MAN), however, those skilled in the art will appreciate that embodiments are not limited thereto, and may include smaller-scale networks, such as LANS (local area networks). Thus, aspects of the one or more embodiments described herein may be implemented on one or more computers executing software instructions, and the computers may be networked in a client-server arrangement or similar distributed computer network.

With ever increasing amounts of data to be backed up on a regular basis, and with strict rate requirements of backup and restore operations, maintaining the health of backup system infrastructure is of critical importance in present large-scale data processing systems. The health of a system, as quantified by its ability to maintain the operational parameters set during its initial installation, must be maintained during the operational life of the system to ensure expected data protection performance. Many different events and conditions can affect the hardware and software components of a system in ways that negatively affect this system health. Software bugs or bad configuration and setup can cause problems, as can hardware problems, such transmission and interface issues, CPU problems (e.g., clock drift, environmental stress, etc.), and so on. Other problems may be caused by changes to configuration parameters, integration issues, storage media failures, data unavailability, upgrade failures, and so on. Any number and type of issues can cause or be associated with problems and failure conditions that are characterized as internal backup server or system health.

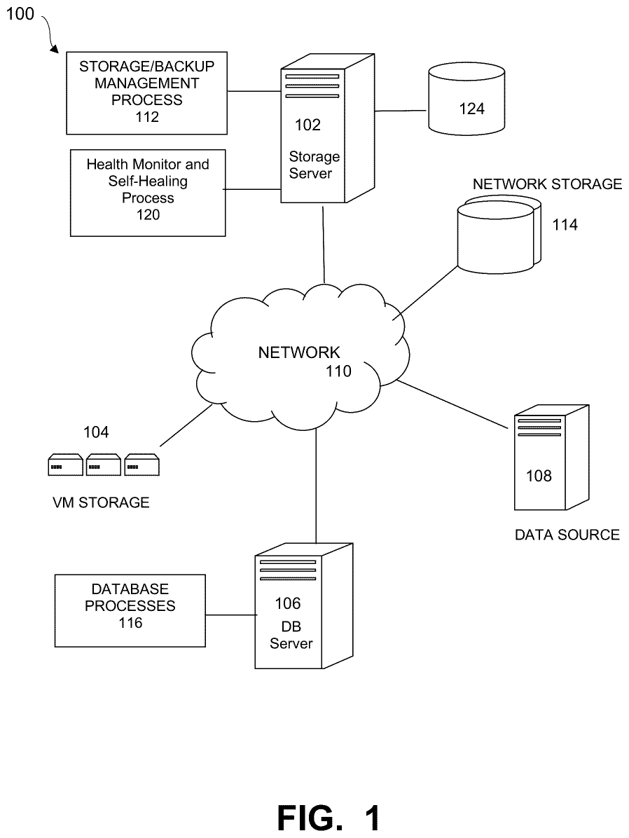

Embodiments are directed to a system and method that utilizes certain artificial intelligence methods to detect and classify such problems, and instigate measures to self-heal the system to maintain the overall server and system health. FIG. 1 illustrates a computer network system that implements one or more embodiments of a backup system implementing a backup server health and resiliency process 120. In system 100, a storage server 102 executes a data storage or backup management process 112 that coordinates or manages the backup of data from one or more data sources 108 to storage devices, such as network storage 114, client storage, and/or virtual storage devices 104.

With regard to virtual storage 104, any number of virtual machines (VMs) or groups of VMs (e.g., organized into virtual centers) may be provided to serve as backup targets. The VMs or other network storage devices serve as target storage devices for data backed up from one or more data sources, such as storage server 102 or data source 108, in the network environment. The data sourced by the data source may be any appropriate data, such as database data that is part of a database management system, and the data may reside on one or more hard drives for the database(s) in a variety of formats. Thus, a data source maybe a database server 106 executing one or more database processes 116, or it may be any other sources data for use by the resources of network 100.

The network server computers are coupled directly or indirectly to the data storage 114, target VMs 104, and the data sources and other resources through network 110, which is typically a cloud network (but may also be a LAN, WAN or other appropriate network). Network 110 provides connectivity to the various systems, components, and resources of system 100, and may be implemented using protocols such as Transmission Control Protocol (TCP) and/or Internet Protocol (IP), well known in the relevant arts. In a cloud computing environment, network 110 represents a network in which applications, servers and data are maintained and provided through a centralized cloud computing platform.

The data generated or sourced by system 100 and transmitted over network 110 may be stored in any number of persistent storage locations and devices. In a backup case, the backup process 112 causes or facilitates the backup of this data to other storage devices of the network, such as network storage 114. In an embodiment network 100 may be implemented to provide support for various storage architectures such as storage area network (SAN), Network-attached Storage (NAS), or Direct-attached Storage (DAS) that make use of large-scale network accessible storage devices 114, such as large capacity disk (optical or magnetic) arrays, such as RAID (redundant array of individual disk) arrays. In an embodiment, system 100 may represent a Data Domain Restorer (DDR)-based deduplication storage system, and storage server 102 may be implemented as a DDR Deduplication Storage server provided by EMC Corporation. However, other similar backup and storage systems are also possible.

Disaster recovery and data restore applications typically involve a data backup system for backing up database data. One example is a Dell PowerProtect data management system that is a software defined data protection system including automated discovery, data deduplication, self-service and IT governance for physical, virtual and cloud environments.

As stated above, certain problems with respect to backup/restore operations may be caused by problems internal to the backup server 102 or other vendor provided infrastructure. At present, fixing these problems requires the user contact the vendor and utilize their customer service channels, which can be a very time-consuming process.

Embodiments include a health monitor and self-healing process 120 that utilizes certain artificial intelligence (AI) and machine learning (ML) mechanisms to provide dynamic and timely resolution of internal backup server issues and faults. Such internal issues generally include issues associated with software and hardware components, installation, usage, configuration, upgrades, and so on of the backup server, storage, interface, and associated components themselves. Such issues generally do not include external attacks, such as malware, hacking, data theft, sabotage, and other malicious attacks by third party actors, however, embodiments may include external actions that may cause or manifest as internal system issues.

In an embodiment, system 100 implements a Naïve Bayes classifier-based server health resiliency process that greatly helps the amount of time needed to resolve any health-based issue in the server. Using this or similar AI-based classification, process 120 helps allow vendor applications to intelligently identify automatically resolve these flaws without the help of engineers or system admin personnel on the customer environment. In general, such a process uses historical cases and trains certain ML models in such a way that troubleshooting, log analysis and recommendations will be done proactively to identify root causes of an issue or issues and identify and apply available and appropriate fixes and workarounds.

The Naive Bayes is a simple classifier that classifies based on probabilities of problematic or potential failure causing events as based on training data. In an embodiment, past error data from actual system deployment and usage, as well as laboratory data (if available) is compiled to provide a corpus of data used by the classifier.

In an embodiment, the errors and error conditions utilized to train the machine learning algorithm mostly manifest during the execution of a data protection use cases in one or more customer environments. These errors may pertain to configuration parameters, integration configuration issues, known issues in large-scale environments, backup failures, fault tolerance, performance issues, memory leaks, restore failures, data unavailability, data loss, upgrade failure, and so on.

For such an embodiment, certain system parameters and characteristics can be monitored to indicate any detected an out-of-tolerance behavior of a component of the server, such as excessive CPU or memory usage, excessive network traffic, initiation of defensive mechanisms (e.g., firewalls, anti-virus triggers, etc.), and so on. These represent only a few of the thousands of unique issues documented from historical data and the local lab environment over an extended period of time, which were used to train the machine learning model to achieve the highest accuracy possible. Any number of additional or other error conditions can also be used depending on system configuration, applications, and so on. The error notification may be implemented as an GUI provided error message (text or visual warning), indication in a user or system log of an error or anomalous condition, device generated warning, or other similar notification.

In an example implementation, the Naive Bayes model has been trained using a diverse range of data, including information gathered from customer environments and a laboratory implementation, which has been collected for the past 30 years across an extensive customer base. This has yielded over 1 TB of refined and cleansed data that covers most of the use cases in a data protection life cycle. The data was utilized in various portions, depending on the module of the product to be trained with the machine learning algorithm. The historical data set is comprised of numerical data, categorical data, time-series data, and text data, providing a comprehensive and varied range of data for training the model.

To utilize the algorithm, the process 120 uses a labeled dataset is required as input. Each instance or observation within the dataset is labeled with its corresponding category or class. While the features or attributes that describe each instance may be either continuous or discrete, they are typically converted to discrete values before being used with the algorithm.

In an embodiment, a Naive Bayes classifier is used to implement the AI-based classifier. In general, a Naive Bays classifier is a machine learning model under supervised learning which is mainly used for classification use cases. It is based on a mathematical theorem known as Bayes Theorem.

For this algorithm, the term “Naïve” is used because the algorithm assumes that the occurrence of a certain feature is independent of the occurrence of other features. For example, if the fruit is identified on the bases of color, shape, and taste, then orange, spherical, and sweet fruit is predicted to be an orange. Further size and shape features may lead the classification to a tangerine instead of an orange, and so on. Therefore, each feature would individually contribute to identify that the fruit type without depending on each other.

The term Bayes refers to the fact that uses the Bayes theorem, which is as follows:

$$P ( A \vert B ) = ( P ( B \vert A ) P ( A ) ) / P ( B )$$

Where: P(A|B) is Posterior probability: Probability of hypothesis A on the observed event B; P(B|A) is Likelihood probability: Probability of the evidence given that the probability of a hypothesis is true; P(A) is Prior Probability: Probability of hypothesis before observing the evidence; and P(B) is Marginal Probability: Probability of Evidence.

There are three types of Naive Bayes Model, as follows. (1) Gaussian: The Gaussian model assumes that features follow a normal distribution. This means to say that if predictors take continuous values instead of discrete, then the ML model assumes that these values are sampled from the Gaussian distribution. (2) Multinomial: The multinomial Naïve Bayes classifier is mostly used when there is data that is multinomial distributed. The classifier here uses the frequency of words for the predictors. (3) Bernoulli: The Bernoulli classifier works like the Multinomial classifier; the only difference is the predictor variables are the independent Booleans variables. Which means to say that if a particular word is present or not in a document.

Any of these types can be used for the Naive Bayes model utilized by process 120. In addition, other models instead may also be used. For example, the LR+regularization model can be an alternate to this model under alternative embodiments.

In general, the Naïve Bayes algorithm used in process 120 predicts the most accurate fix for any internal server system issue. The manual intervention of the user is minimized to the greatest extent, and the solution ensures a self-heal smart mechanism in the data protection system.

The Naïve Bayes Algorithm provides an efficient way to predict and suggest multiple potential work arounds to the customer and also allow a self-heal technique. The algorithm of process 120 gets trained with historical data from the past customers to predict the best potential fix for any issue. The error codes and the strings are mapped with the predicted value of the potential fix and is applied smartly.

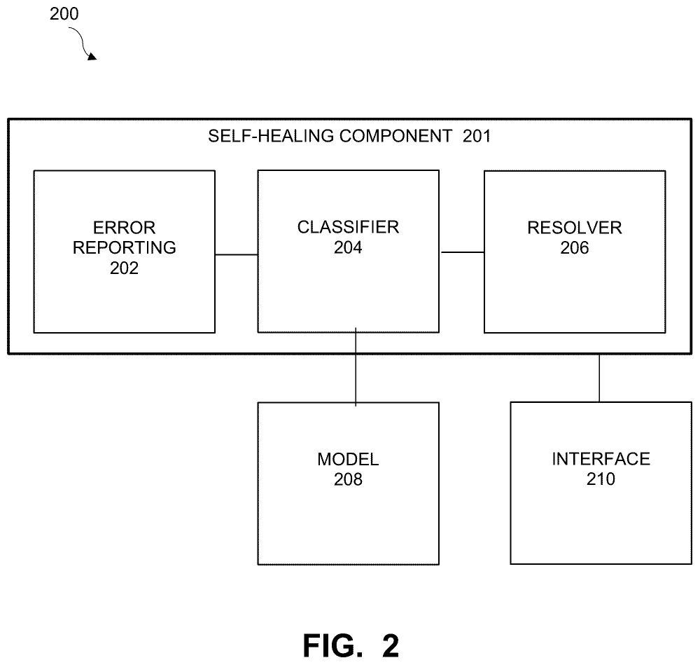

FIG. 2 is a block diagram of a self-healing component for maintaining backup server health, under some embodiments. For the embodiment of FIG. 2, self-healing component 201 comprises an error reporting module 202 that detects or receives error notifications or alerts from the backup system, a classifier 204 that classifies the received or detected error using a classifier 204, such as a Naive Bayes classifier that is trained using model 208. Once the error is classified, a resolver component 206 takes the appropriate measures to fix the error. If an appropriate fix is not available, the system can notify through interface 210, the appropriate vendor personnel for escalation through the necessary vendor channels.

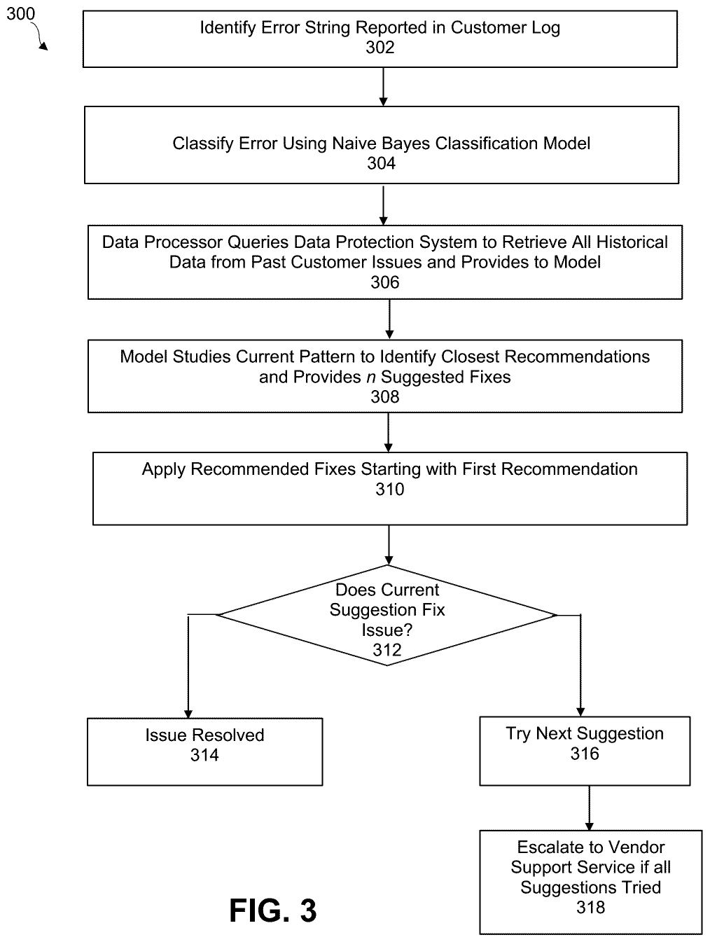

FIG. 3 is a flowchart illustrating a method of performing AI-based server health and resiliency, under some embodiments. Process 200 begins with receiving an indication of a server issue, such as by receiving an alert message or finding an error string reported in a system or user log, 202. The indicated error condition is then classified using the Naive Bayes Classifier, 304. In an embodiment, the PPDM binary is integrated with the classification model.

With respect to the format of the error string, text-based errors are generally logged into module-based log files in a standardized manner across the an industry's product division. Every data protection product incorporates a logging mechanism that generates text data to capture relevant information. This logging mechanism is programmable and can be customized to include additional details in the text-format logs. This flexibility allows for the expansion of information contained within the logs, accommodating more data pertaining to the errors and enhancing the log's comprehensiveness.

With respect to how an error is process for input to the Naive Bayes classifier that is designed for text data, certain steps such as text pre-processing and feature extraction are used. The first step is generally to preprocess the error text to prepare it for classification (text preprocessing). This involves several steps, such as removing punctuation, tokenization (splitting the text into individual words or tokens), removing stop words (common words that do not contribute much to the overall meaning), and applying stemming or lemmatization to reduce words to their base or root form. Additionally, any special characters, numbers, or irrelevant symbols may be removed. The purpose of text preprocessing is to standardize the input and reduce noise, making the data more suitable for analysis by the Naive Bayes algorithm.

Once the text has been preprocessed, features need to be extracted (feature extraction) from the error data to represent it in a format that the Naive Bayes algorithm can work with. Commonly used techniques for feature extraction include bag-of-words (representing the text as a collection of unique words and their frequencies), n-grams (capturing sequences of multiple words), or term frequency-inverse document frequency (TF-IDF) (highlighting the importance of words in a document relative to a corpus). These techniques convert the text into numerical representations that can be used as input for the Naive Bayes classifier. The extracted features serve as the basis for the algorithm to learn and classify new error instances based on the patterns observed in the training data.

In an embodiment, the deduplication backup server 102 (e.g., PPDM system) is integrated with the classification model meaning that the data protection product has been enhanced by leveraging a machine learning model specifically designed for classification tasks. In general, implementing or leveraging a classification model like Naive Bayes in a data protection product typically involves the steps of data collection, data pre-processing, feature selection/extraction, model training, model evaluation, hyperparameter tuning, and integration into the data protection system, as well as testing and deployment, among other possible steps.

The data collection step gathers a labeled dataset that includes examples of data instances along with their corresponding class labels. The data should be representative of the problem domain and cover a range of scenarios relevant to the data protection product. The data pre-processing step cleans and preprocess the collected data to ensure its quality and suitability for the classification model. This may involve removing duplicates, handling missing values, normalizing or scaling numerical features, and encoding categorical variables.

The feature selection/extraction step identifies relevant features or attributes from the preprocessed data that are most informative for the classification task. This step aims to reduce dimensionality and focus on the most discriminative features. The model training step splits the preprocessed data into training and validation sets. Use the training set to train the Naive Bayes classification model by estimating the conditional probabilities of features given each class. The model learns the underlying patterns and relationships between the features and the class labels during this training process. The model evaluation step evaluates the performance of the trained Naive Bayes model using the validation set or through cross-validation techniques. Common evaluation metrics include accuracy, precision, recall, F1 score, and area under the ROC curve (AUC-ROC). The hyperparameter tuning step fine tunes the model's hyperparameters to optimize its performance. This may involve adjusting parameters such as smoothing techniques, feature selection methods, or parameter priors in the Naive Bayes algorithm.

Finally, the integration step integrates the trained and tuned Naive Bayes classification model into the data protection product. This typically involves developing the necessary software components or APIs to incorporate the model's functionality into the product's workflow. A testing and deployment may be involved to thoroughly test the integrated classification model within the data protection product to ensure its accuracy, reliability, and compatibility with different use cases. Once the model passes the testing phase, it can be deployed to the production environment as part of the data protection product.

With reference back to FIG. 3, in some cases, permission access details may be required from the user, in which case such permission and information is presumed to be provided, otherwise further diagnosis and remediation may not be possible. Assuming user permission is provided, the data processor queries the data protection system to retrieve all historical detail from past customer issues and passes this on to the classification model, 306. The Naive Bayes trained model studies the pattern to generate a number of possible recommendations that comprise suggested fixes to the issue. 308. The Naive Bayes trained model “studies” the pattern by analyzing the incoming data, extracting relevant features, estimating probabilities, and learning the relationships between the features and labels through training. It then uses this learned information to recognize patterns in new data and generate recommendations or suggested fixes based on the observed features.

Any appropriate number of recommendations is possible depending on system configuration, and typically a number between three to ten suggestions are provided. The suggestions may be provided in descending order of probability of success. That is, the most likely recommendation is provided first, followed by the next most likely, and so on. In some cases, a recommended fix may involve a combination of recommended steps, in which case, the recommendations may comprise combinations of fixes or suggested fixes with a recipe for combination.

In an embodiment, the recommendation is provided to the user in the form of an automated script that contains multiple potential solutions. The user is then given the option to grant permission for the system to apply the best-fit workaround as suggested by the algorithm. Additionally, the user has the freedom to choose from the list of provided workarounds, providing them with flexibility in selecting the solution that best suits their needs.

The resolver component 206 then applies the recommended fixes starting with the highest recommendation first, 310. If this recommendation solves the problem, as determined in decision block 312, the issue is resolved 314. Otherwise, the next suggested fix is tried, 316. Each suggested fix is tried until the issue is resolved, 314, otherwise, if no suggested fix works, the issue is escalated through interface 210 to the vendor customer service or other personnel for resolution, 318.

As shown in process 300, the resolution of an issue is determined once the Machine Learning recommendation applies an automated smart fix to the identified problem. The recommended workaround is carefully tested to ensure that when applied to the faulty area of operation, it passes the automated test case's scoreboard and the input pattern matches the scoreboard pattern.

In an embodiment, the term “scoreboard” refers to a cumulative value that is calculated to evaluate the success of the test cases. It is a threshold value that represents the effectiveness or resolving capability of a particular test case. The higher the score on the scoreboard, the more successful the test case is considered to be. For example, if there is a test case has a resolving capability of 100% (meaning it can accurately resolve the identified problem every time), the this would have a scoreboard value of 100. The scoreboard acts as a measure of confidence in the test case's ability to provide a reliable solution.

When the ML recommendation applies an automated smart fix to the identified problem, the recommended workaround is carefully tested. The test evaluates whether the applied fix passes the automated test case's scoreboard. In other words, the fix is compared against the expected outcomes of the test case, and if it successfully matches the scoreboard pattern, it is considered a valid solution. If the recommended workaround aligns with the scoreboard pattern, it indicates that the ML model's recommendation has a similar resolving capability as the successful test case. This provides confidence that the recommended fix can be applied in the customer environment, as it has demonstrated a high likelihood of resolving the identified problem.

By using the scoreboard pattern as a threshold, the system can ensure that the recommended workaround has a proven track record of success similar to the test cases that have achieved a high resolving capability. This approach helps validate the effectiveness of the ML recommendation and provides assurance that the recommended fix is reliable for implementation. Overall, the scoreboard serves as a reference point to determine whether the ML recommendation's pattern of success matches that of the tested and successful test cases, thereby ensuring the reliability of the recommended workaround.

The Naive Bayes model suggests the best-fit solution to the detected error, and with the customer's approval, the workaround is implemented. If the applied workaround passes the threshold scoreboard and the operation functions as expected, the issue is considered resolved. As described above, the system 100 is configured to automatically implement the best-tested recommendation provided by the Naive Bayes model. This would involve integrating the model's output into the system's workflow and automating the execution of the recommended fix without requiring explicit user involvement.

Example backup server/system issues that can be self-healed based on detected errors include constant crashing of a virtual proxy (vProxy) because of the log fill up. In this case, the detected error is a log overfill condition, and the resolver 206 will automatically save the log into a data lake and delete the logs to empty the NAS container and then proceed with the vProxy operations. Another example case is where a firewall blockage continuously throws popup messages to the end user through their web browser. In this case, the resolver 206 applies appropriate firewall filters to all the problematic port. Many other similar examples are also possible depending on applications and system configuration. The classifier 202 is used to intelligently decipher the received error notification and determine and provide to the user most likely fixes based on historical data from regular system usage and/or/laboratory data from theoretical information.

Embodiments above describe the use of a Naive Bayes classifier as implementing the classifier component 204, however, embodiments are not so limited. Other ML-based classifiers can also be used, such as KNN (k-nearest neighbors) or SVM (support vector machine) processes, and choice of classification method may depend on the specific requirements of a particular use case.

The KNN (K-Nearest Neighbors) algorithm is a non-parametric, lazy learning method that classifies data based on the similarity of features between neighboring instances. The algorithm calculates the distance between the new instance and its K nearest neighbors in the training set to determine the class label. KNN is simple to implement and works well when there is a lot of training data, but it can be computationally expensive and slow for large datasets.

The SVM (Support Vector Machine) approach is a supervised machine learning algorithm that can be used for classification and regression analysis. It works by finding the best hyperplane that separates the data into distinct classes. SVM is particularly useful when dealing with complex datasets with non-linear boundaries, but it can be sensitive to the choice of kernel function and requires careful tuning of parameters.

For the server health and resiliency component 120, both KNN and SVM could be effective for classifying the health status of the server. However, the specific features used for classification, such as CPU usage, disk utilization, network traffic, etc., should be carefully selected to ensure that they are relevant to the problem. Additionally, the performance requirements, such as the speed of classification and memory usage, should be considered when choosing an algorithm.

With respect to the KNN, process, KNN basically stands for k-nearest neighbors (KNN) algorithm, and is a classification algorithm that can be well used in case of classification and regression scenarios. KNN is a supervised learning algorithm that is dependent upon the labelled input data to study a function that would produce an output when a new unlabeled data is given as input. It classifies the data point on how its neighbor is classified. The basic principle of this model is to classify any new input data based on the similarity measure of the data points which was stored earlier.

For example, consider a dataset of fruits comprising coconuts and grapes. The KNN model will get trained with similar measures like shape, color, weight, etc. When some random fruit is processed, KNN will try to match its similarity with the color (red or yellow), weight and shape. A similar process can be used with the properties of data object that are used to tailor the KNN model to fit the server health embodiment. Any new error message processed by the system can be classified into a known error type certain defined attributes or patterns. In this process, ‘K’ in KNN signifies the number of the nearest neighbors that would be leveraged to classify new data points (e.g., new Virtual Machines/Docker/any data object).

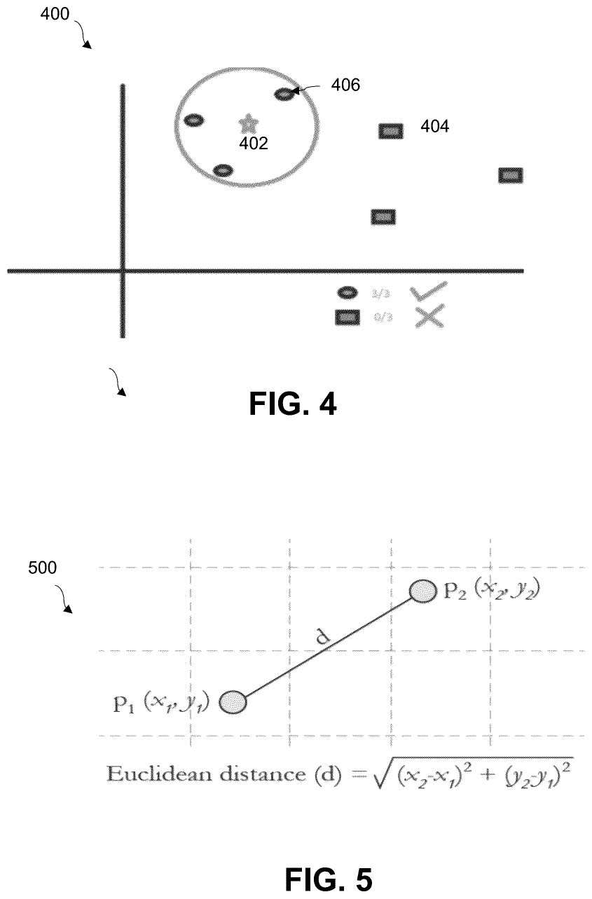

FIG. 4 illustrates a simple example depiction of a KNN implementation that can be used for a server health and resiliency component, under some embodiments. Plot 400 of FIG. 4 shows that if a new input (star 402) is to be classified into a circle 406 or rectangle 404, then the KNN model would calculate the Euclidian distance between the “Star-Circle” and “Star-Rectangle” for three occurrences (K=3). Since the three circles 406 are closest to the new data 402, this star 402 would be classified as circle 406.

FIG. 5 illustrates a plot representation 500 for the calculation of Euclidean distance for a KNN implementation, under some embodiments. As shown in FIG. 5, the Euclidean distance (d) between points P₁ (x₁, y₁) and P₂ (x₂, y₂) is calculated by the following formula:

$$d = SQRT ( {( {x}_{2} - {x}_{1} )}^{2} + {( {y}_{2} - {y}_{1} )}^{2} )$$

Besides the KNN classifier, an SVM algorithm may also be used. The SVM algorithm attempts to create the best line or decision boundary that can segregate n-dimensional space into classes so that a new data point ca be put in the correct category in the future. This best decision boundary is called a hyperplane, and SVM chooses the extreme points/vectors that help in creating the hyperplane, where these extreme cases are called as support vectors.

For the server health and resiliency component and method, some relevant parameters that can be used to train the KNN and SVM models include:

CPU usage: high CPU usage can indicate that the server is under heavy load and may be at risk of failure.

Memory usage: memory leaks and excessive memory usage can lead to crashes and other issues.

Disk utilization: disk space can become a bottleneck for server performance if it becomes too full.

Network traffic: high network traffic can indicate a surge in user activity or potential network congestion.

Error logs: Analyzing error logs can help identify issues before they cause system failure.

Response time: monitoring the response time of the server can help detect performance issues before they become critical.

System availability: keeping track of the uptime and availability of the server can help identify potential reliability issues.

Security events: analyzing security events can help detect and prevent attacks that could compromise the server's resiliency.

The above list is provided for example only, and embodiments are not so limited. Other or different characteristics regarding system performance can be used. In general, the choice of these above parameters for either KNN or SVM will depend on the specific requirements and constraints of the use case. It is generally important to select features that are relevant to the problem and provide a good representation of the system's health and resiliency. The performance of the KNN and SVM models can be evaluated using metrics such as accuracy, precision, recall, and F1 score.

For these metrics, accuracy measures the overall correctness of the model's predictions by comparing the number of correct predictions to the total number of predictions made. It is calculated as the ratio of the number of correct predictions to the total number of predictions. For example, if a model correctly predicts 90 out of 100 instances, the accuracy would be 90%. Both KNN and SVM models can be evaluated using accuracy. A higher accuracy indicates that the model is making more correct predictions, while a lower accuracy suggests the model's predictions are less reliable.

The precision metric measures the proportion of correctly predicted positive instances out of all instances predicted as positive. It is a useful metric when the focus is on minimizing false positives. Precision is calculated as the ratio of true positives (correctly predicted positive instances) to the sum of true positives and false positives. In the case of KNN and SVM models, precision can be calculated to assess their ability to correctly identify positive instances (e.g., classifying an email as spam). Higher precision indicates a lower rate of false positives, which means the model is more precise in its positive predictions.

The recall metric, also known as sensitivity or true positive rate, measures the proportion of correctly predicted positive instances out of all actual positive instances. It is particularly relevant when the goal is to minimize false negatives. Recall is calculated as the ratio of true positives to the sum of true positives and false negatives. Both KNN and SVM models can be evaluated using recall. A higher recall suggests that the model is effectively identifying positive instances from the total pool of actual positive instances. A lower recall indicates a higher rate of false negatives, meaning the model is missing some positive instances.

The F1 score combines precision and recall into a single metric, providing a balanced evaluation of a model's performance. It is the harmonic mean of precision and recall and gives equal weightage to both metrics. The F1 score is useful when there is an uneven class distribution or when both false positives and false negatives need to be considered. KNN and SVM models can be compared based on their F1 scores. A higher F1 score indicates a better balance between precision and recall, implying that the model is performing well in terms of both minimizing false positives and false negatives.

In summary, while evaluating the performance of KNN and SVM models, accuracy gives an overall measure of correctness, precision assesses false positives, recall assesses false negatives, and the F1 score provides a balanced evaluation by considering both precision and recall. These metrics collectively help understand the strengths and weaknesses of the models in different aspects of classification tasks.

As used herein, “supervised learning” refers to a subcategory of machine learning (ML) and artificial intelligence (AI) that is defined by the use of labeled datasets to train algorithms that to classify data or predict outcomes accurately.

As shown in FIG. 2, the model for the classifier 204 is trained using historical data, and laboratory data if appropriate. This training generally involves analyzing historical data for the defined attributes and deriving priorities from that data. In an embodiment, the self-healing component 201 utilizes certain artificial intelligence (AI) and machine learning (ML) processes to evaluate different error notifications for resolution. Such a process generally uses a training component that continuously trains a machine learning algorithm.

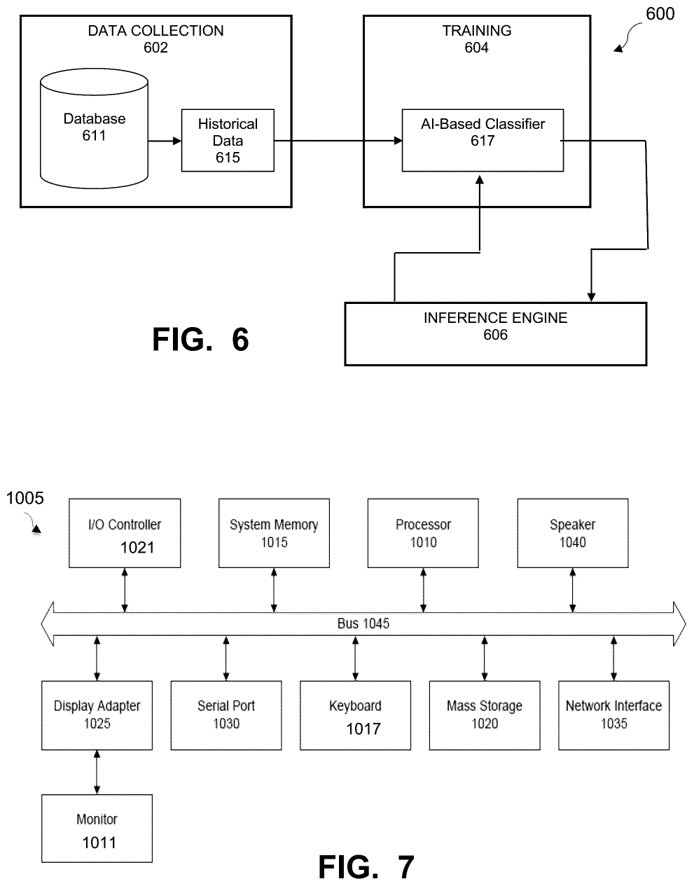

FIG. 6 illustrates a general AI/ML component used in a server health component, under some embodiments. System 600 of FIG. 6 includes a data collection component 602, a training component 604, and an inference component 606. The data collection component 602 can comprise various data loggers and I/O capture devices and databases 611 along with a body of historical information 615 about past events (e.g., backups). The data collection component 602 continuously monitors and collects event data to build up its database. This collected information is submitted to the training component 604 through an AI-based analyzer 617. This component continuously trains a machine learning algorithm to identify the event attributes to thereby determine an issue associated with an error message or notification. The inference engine 606 also continuously trains the AI/ML algorithms through monitored events.

The system of FIG. 1 may comprise any number of computers or computing devices in client-server networks including virtual machines coupled over the Internet or similar large-scale network or portion thereof. Each processing device in the network or data protection system may comprise a computing device capable of executing software code to perform the processing steps described herein. FIG. 7 is a system block diagram of a computer system used to execute one or more software components of the present system described herein. The computer system 1005 includes a monitor 1011, keyboard 1017, and mass storage devices 1020. Computer system 1005 further includes subsystems such as central processor 1010, system memory 1015, input/output (I/O) controller 1021, display adapter 1025, serial or universal serial bus (USB) port 1030, network interface 1035, and speaker 1040. The system may also be used with computer systems with additional or fewer subsystems. For example, a computer system could include more than one processor 1010 (i.e., a multiprocessor system) or a system may include a cache memory.

Arrows such as 1045 represent the system bus architecture of computer system 1005. However, these arrows are illustrative of any interconnection scheme serving to link the subsystems. For example, speaker 1040 could be connected to the other subsystems through a port or have an internal direct connection to central processor 1010. The processor may include multiple processors or a multicore processor, which may permit parallel processing of information. Computer system 1005 is but an example of a computer system suitable for use with the present system. Other configurations of subsystems suitable for use with the present invention will be readily apparent to one of ordinary skill in the art.

Computer software products may be written in any of various suitable programming languages. The computer software product may be an independent application with data input and data display modules. Alternatively, the computer software products may be classes that may be instantiated as distributed objects. The computer software products may also be component software.

An operating system for the system may be one of the Microsoft Windows®, family of systems (e.g., Windows Server), Linux, Mac OS X, IRIX32, or IRIX64. Other operating systems may be used.

Furthermore, the computer may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11x), near field communication (NFC), radio-frequency identification (RFID), mobile or cellular wireless. For example, signals from a computer may be transferred, at least in part, wirelessly to components or other computers.

For the sake of clarity, the processes and methods herein have been illustrated with a specific flow, but it should be understood that other sequences may be possible and that some may be performed in parallel, without departing from the spirit of the invention. Additionally, steps may be subdivided or combined. As disclosed herein, software written in accordance with the present invention may be stored in some form of computer-readable medium, such as memory or CD-ROM, or transmitted over a network, and executed by a processor. More than one computer may be used, such as by using multiple computers in a parallel or load-sharing arrangement or distributing tasks across multiple computers such that, as a whole, they perform the functions of the components identified herein; i.e. they take the place of a single computer. Various functions described above may be performed by a single process or groups of processes, on a single computer or distributed over several computers. Processes may invoke other processes to handle certain tasks. A single storage device may be used, or several may be used to take the place of a single storage device.

For the sake of clarity, the processes and methods herein have been illustrated with a specific flow, but it should be understood that other sequences may be possible and that some may be performed in parallel, without departing from the spirit of the invention. Additionally, steps may be subdivided or combined. As disclosed herein, software written in accordance with the present invention may be stored in some form of computer-readable medium, such as memory or CD-ROM, or transmitted over a network, and executed by a processor. More than one computer may be used, such as by using multiple computers in a parallel or load-sharing arrangement or distributing tasks across multiple computers such that, as a whole, they perform the functions of the components identified herein; i.e., they take the place of a single computer. Various functions described above may be performed by a single process or groups of processes, on a single computer or distributed over several computers. Processes may invoke other processes to handle certain tasks. A single storage device may be used, or several may be used to take the place of a single storage device.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

All references cited herein are intended to be incorporated by reference. While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A computer-implemented method of self-healing problems in a data protection network, comprising:
identifying an error condition in a server of the network;
classifying the error condition using an artificial intelligence (AI) based classifier trained using a model;
querying, by a data processor, the network to retrieve historical data of past network issues;
studying a pattern of the identified error condition to identify one or more recommendations for a fix to the identified error condition; and
applying the recommendations in a priority order until one of resolution of the error condition or exhaustion of all of the one or more recommendations without resolution is achieved.

2. The method of claim 1 wherein the error condition is identified by at least one of: receiving an error notification through in interface, identifying an error message in an event log, and detecting an out-of-tolerance behavior of a component of the server.

3. The method of claim 2 wherein the out-of-tolerance behavior comprises at least one of an excessive processor usage, memory usage, or network bandwidth usage.

4. The method of claim 2 wherein the model is trained using error conditions manifest during the execution of a data protection program in one or more customer environments.

5. The method of claim 4 wherein the error conditions comprise at least one of: configuration parameter faults, integration configuration issues, large-scale environment problems, backup failures, fault tolerance, performance issues, memory leaks, restore failures, data unavailability, data loss, or upgrade failure.

6. The method of claim 1 wherein the classifier comprises one of a Naive Bayes classifier, a k-nearest neighbors (KNN) algorithm, or a support vector machine (SVM) algorithm.

7. The method of claim 6 further comprising training a model for one of the KNN or SVM algorithm using at least one of CPU usage, memory usage, disk utilization, network traffic, error logs, system response time, system availability, or security events.

8. The method of claim 1 wherein the classifying utilizes an artificial intelligence (AI) based component comprising a data collection component, a training component, and an inference component, and contains historical information regarding performance of the network to continuously train a machine learning (ML) algorithm to identify system issues including the error.

9. The method of claim 8 wherein the network comprises a PowerProtect Data Domain deduplication backup system.

10. A system for dynamically prioritizing backups of datasets in a network, comprising:
a monitor identifying an error condition in a server of the network;
a classifier classifying the error condition using an artificial intelligence (AI) based classifier trained using a model;
a data processor querying the network to retrieve historical data of past network issues, and studying a pattern of the identified error condition to identify one or more recommendations for a fix to the identified error condition; and
a resolver component applying the recommendations in a priority order until one of issue resolution or exhaustion of all of the one or more recommendations without resolution is achieved.

11. The system of claim 10 wherein the error condition is identified by at least one of: receiving an error notification through in interface, identifying an error message in an event log, and detecting an out-of-tolerance behavior of a component of the server, and wherein the out-of-tolerance behavior comprises at least one of an excessive processor usage, memory usage, or network bandwidth usage.

12. The system of claim 11 wherein the model is trained using error conditions manifest during the execution of a data protection program in one or more customer environments, and wherein the error conditions comprise at least one of: configuration parameter faults, integration configuration issues, large-scale environment problems, backup failures, fault tolerance, performance issues, memory leaks, restore failures, data unavailability, data loss, or upgrade failure.

13. The system of claim 12 wherein the classifier comprises one of a Naive Bayes classifier, a k-nearest neighbors (KNN) algorithm, or a support vector machine (SVM) algorithm.

14. The system of claim 13 further comprising training a model for one of the KNN or SVM algorithm using at least one of CPU usage, memory usage, disk utilization, network traffic, error logs, system response time, system availability, or security events.

15. The system of claim 10 wherein the classifying utilizes an artificial intelligence (AI) based component comprising a data collection component, a training component, and an inference component, and contains historical information regarding performance of the network to continuously train a machine learning (ML) algorithm to identify system issues including the error.

16. The system of claim 15 wherein the network comprises a PowerProtect Data Domain deduplication backup system.

17. A tangible computer program product having stored thereon program instructions that, when executed by a process, cause the processor to perform a method of prioritizing backups of container data in a network, comprising:
identifying an error condition in a server of the network;
classifying the error condition using an artificial intelligence (AI) based classifier trained using a model;
querying, by a data processor, the network to retrieve historical data of past network issues;
studying a pattern of the identified error condition to identify one or more recommendations for a fix to the identified error condition; and
applying the recommendations in a priority order until one of issue resolution or exhaustion of all of the one or more recommendations without resolution is achieved.

18. The product of claim 17 wherein the error condition is identified by at least one of: receiving an error notification through in interface, identifying an error message in an event log, and detecting an out-of-tolerance behavior of a component of the server, and wherein the out-of-tolerance behavior comprises at least one of an excessive processor usage, memory usage, or network bandwidth usage.

19. The product of claim 18 wherein the model is trained using error conditions manifest during the execution of a data protection program in one or more customer environments, and wherein the error conditions comprise at least one of: configuration parameter faults, integration configuration issues, large-scale environment problems, backup failures, fault tolerance, performance issues, memory leaks, restore failures, data unavailability, data loss, or upgrade failure.

20. The product of claim 19 wherein the classifying utilizes an artificial intelligence (AI) based component comprising a data collection component, a training component, and an inference component, and contains historical information regarding performance of the network to continuously train a machine learning (ML) algorithm to identify system issues including the error.
